(19) United States
(12) Patent Application Publication
(10) Pub. No.: US 2012/0027438 A1
(43) Pub. Date: Feb. 2, 2012

(54) IMAGE FORMING APPARATUS

(76) Inventors: Naoki MIZUTANI, Osaka (JP); Naoki YAMANE, Osaka (JP); Kazuya YAMASHITA, Osaka (JP); Kohshiroh TOMIMORI, Osaka (JP)

(21) Appl. No.: 13/180,661

(22) Filed: Jul. 12, 2011

(30) Foreign Application Priority Data
Jul. 30, 2010 (JP) P2010-172217

(51) Int. Cl. G03G 21/12

(52) U.S. Cl. 399/35

(57) ABSTRACT

An image forming apparatus includes: a storage container which horizontally stores a waste toner; a full detection sensor which detects whether the waste toner reaches a full position; a near detection sensor which detects whether the waste toner reaches a near position; and a conveyance portion which is provided inside the storage container, includes an axial rod, and rotates about the axial rod, wherein the conveyance portion includes: a first spiral protrusion which conveys the waste toner to the near position; a second spiral protrusion which conveys the waste toner from the near position to the full position; and a third range which is provided between the first spiral protrusion and the second spiral protrusion and through which the waste toner passes at a speed lower than the conveyance speed of the first spiral protrusion and the second spiral protrusion.

### BACKGROUND OF THE INVENTION

1. Field of the Invention

Priority is claimed on Japanese Patent Application No. 2010-172217, filed Jul. 30, 2010, the content of which is incorporated herein by reference.

The present invention relates to an image forming apparatus.

2. Description of Related Art

In electro-photographic image forming apparatuses such as copying machines or printers according to the related art, residual toner adhered to a photosensitive drum, an intermediate transfer belt, or the like is cleaned by a cleaner and is collected into a dedicated waste toner container. When the waste toner container is fully filled with the waste toner, the waste toner container is replaced. The waste toner container has a near detection sensor and a full detection sensor attached thereto, where the near detection sensor is configured to detect that the waste toner container is nearly fully filled with the waste toner and the full detection sensor is configured to detect that the waste toner container is fully filled with the waste toner. When the near detection sensor detects that the waste toner container is nearly fully filled with the waste toner, a user is urged to replace the waste toner container via a notification unit such as a touch panel. Further, when the full detection sensor detects that the waste toner container is fully filled with the waste toner, the image forming operation is stopped. The waste toner collection device as described above is disclosed, which gradually detects the amount of the waste toner collected by the waste toner container by using a plurality of sensors.

Hereinafter, the position where the near detection sensor is to be attached is referred to as the near position, and the state in which the waste toner container is nearly fully filled with the waste toner and which is detected by the near detection sensor is referred to as near detection. Further, the position where the full detection sensor is to be attached is referred to as the full position, and the state in which the waste toner container is fully filled with the waste toner and which is detected by the full detection sensor is referred to as full detection.

In the related art, when the distance between the near position and the full position is close, there is a possibility of erroneous detection in which full detection occurs immediately after near detection or in which full detection occurs before near detection. Therefore, the image forming operation may be stopped immediately after the request of the replacement of the waste toner container or the image forming operation may be stopped without the request of the replacement of the waste toner container.

### SUMMARY OF THE INVENTION

According to an aspect of the invention, there is provided an image forming apparatus including: a storage container which horizontally stores waste toner received from a storage port; a full detection sensor which detects whether the waste toner reaches a full position that is the end at the opposite side of the storage port inside the storage container; a near detection sensor which detects whether the waste toner reaches a near position closer to the storage port than the full position; and a conveyance portion which is provided inside the storage container, includes an axial rod, and rotates about the axial rod, wherein the conveyance portion includes: a first spiral protrusion which conveys the waste toner to the near position; a second spiral protrusion which conveys the waste toner from the near position to the full position; and a third range which is provided between the first spiral protrusion and the second spiral protrusion and through which the waste toner passes at a speed lower than the conveyance speed of the first spiral protrusion and the second spiral protrusion.

According to the image forming apparatus as described above, since the speed of conveying the waste toner in the third range is lower than those of the first spiral protrusion and the second spiral protrusion, it takes a certain amount of time for the waste toner to move to the position of the full detection sensor after it moves to the position of the near detection sensor. For this reason, it is possible to prevent erroneous detection in which full detection occurs immediately after near detection or in which full detection occurs before near detection.

### BRIEF DESCRIPTION OF THE DRAWINGS

FIG. 1 is a cross-sectional view illustrating a schematic configuration of a multifunctional machine A according to an embodiment of the invention.

FIG. 2 is a perspective view illustrating a waste toner container 24 of the multifunctional machine A according to the embodiment of the invention.

FIG. 3A is a cross-sectional view taken along the line X-X of the waste toner container 24 of the multifunctional machine A according to the embodiment of the invention.

FIG. 3B is a cross-sectional view taken along the line Y-Y of the waste toner container 24 of the multifunctional machine A according to the embodiment of the invention.

FIG. 4A is a cross-sectional view taken along the line X-X indicating the stream of waste toner in the waste toner container 24 of the multifunctional machine A according to the embodiment of the invention.

FIG. 4B is a cross-sectional view taken along the line Y-Y indicating the stream of the waste toner in the waste toner container 24 of the multifunctional machine A according to the embodiment of the invention.

FIG. 4C is a cross-sectional view taken along the line X-X indicating the stream of the waste toner in the waste toner container 24 of the multifunctional machine A according to the embodiment of the invention.

FIG. 4D is a cross-sectional view taken along the line Y-Y indicating the stream of the waste toner in the waste toner container 24 of the multifunctional machine A according to the embodiment of the invention.

FIG. 5A is a cross-sectional view taken along the line X-X indicating the stream of the waste toner in the waste toner container 24 of the multifunctional machine A according to the embodiment of the invention.

FIG. 5B is a cross-sectional view taken along the line Y-Y indicating the stream of the waste toner in the waste toner container 24 of the multifunctional machine A according to the embodiment of the invention.

FIG. 5C is a cross-sectional view taken along the line X-X indicating the stream of the waste toner in the waste toner container 24 of the multifunctional machine A according to the embodiment of the invention.

FIG. 5D is a cross-sectional view taken along the line Y-Y indicating the stream of the waste toner in the waste toner container 24 of the multifunctional machine A according to the embodiment of the invention.

FIG. 6A is a schematic diagram illustrating a conveyance portion 24d of a multifunctional machine A according to a modified example of the embodiment of the invention.

FIG. 6B is a schematic diagram illustrating a conveyance portion 24d of a multifunctional machine A according to another modified example of the embodiment of the invention.

### DETAILED DESCRIPTION OF THE INVENTION

An object of the invention is to prevent erroneous detection in which full detection occurs immediately after near detection or full detection occurs before near detection.

Hereinafter, an exemplary embodiment of the invention will be described by referring to the accompanying drawings.

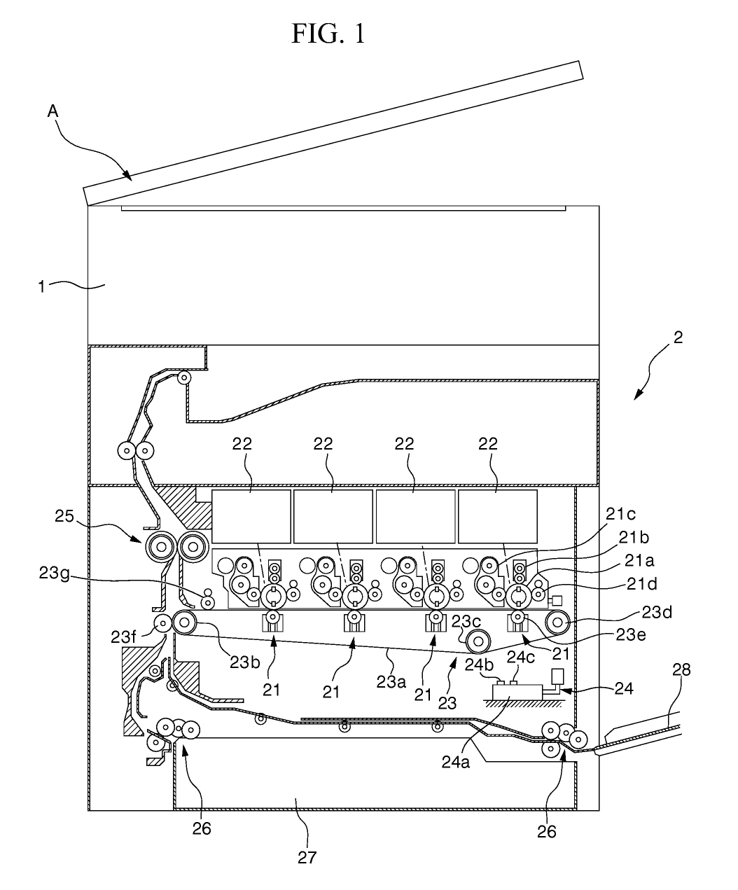

A multifunctional machine (an image forming apparatus) A according to the embodiment is configured to perform copying, printing, and the like in an electro-photographic method. As shown in FIG. 1, the multifunctional machine A includes an image reading device 1 which reads an image of a document, and an image forming device 2 which forms an image on a recording sheet on the basis of image data.

The image reading device 1 reads an image (a document image) of a document placed on a platen glass through a liner sensor and outputs the read image by converting it into document image data.

The image forming device 2 forms an image on a recording sheet conveyed from a sheet feeding cassette 27 or a sheet feeding tray 28 (refer to FIG. 1) on the basis of the image data. As shown in FIG. 1, the image forming device 2 includes a plurality of image forming units 21, a laser scanning unit 22, an intermediate transfer unit 23, a waste toner container 24, a fixing unit 25, a sheet feeding roller 26, a sheet feeding cassette 27, and a sheet feeding tray 28.

The image forming units 21 respectively form an image by using toners of respective colors of yellow (Y), magenta (M), cyan (C), and black (BK). Each of the plurality of image forming units 21 is disposed at a predetermined interval in the horizontal direction when seen from the front side of the multifunctional machine A. As shown in FIG. 1, each image forming unit 21 includes a photosensitive drum 21a, a charger 21b, a developing unit 21c, and a cleaner 21d.

The photosensitive drum 21a is a cylindrical component which forms an electrostatic latent image and a toner image based on the electrostatic latent image on the circumferential surface thereof. The photosensitive drum 21a is disposed to extend in the depth direction when seen from the front side of the multifunctional machine A. A driving unit (not shown) is independently provided at each photosensitive drum 21a so as to adjust the speed thereof. By adopting the driving unit, the photosensitive drum 21a rotates in the circumferential direction during an image forming process.

The charger 21b is disposed to face the photosensitive drum 21a and makes the circumferential surface of the photosensitive drum 21a be in a charged state.

The developing unit 21c supplies toner to the circumferential surface of the photosensitive drum 21a. Consequently, a toner image based on the electrostatic latent image is formed (is developed) on the circumferential surface of the photosensitive drum 21a.

The cleaner 21d removes toner remaining on the photosensitive drum 21a after the toner image is transferred from the photosensitive drum 21a to an intermediate transfer unit 23 (specifically, an intermediate transfer belt 23a) to be described later. The cleaner 21d includes a cleaning roller, a cleaning blade, or the like.

The laser scanning unit 22 is disposed above each image forming unit 21. The laser scanning unit 22 scans the circumferential surface of each charged photosensitive drum 21a through a laser beam so as to form an electrostatic latent image corresponding to each color thereon.

The intermediate transfer unit 23 is disposed below the plurality of image forming units 21. The intermediate transfer unit 23 includes the intermediate transfer belt 23a, a driving roller 23b, a tension roller 23c, a driven roller 23d, a primary transfer roller 23e, a secondary transfer roller 23f, and a cleaning portion 23g.

The intermediate transfer belt 23a is a recording medium to which a toner image is firstly transferred from the plurality of image forming units 21, and is suspended on the driving roller 23b, the tension roller 23c, and the driven roller 23d.

The driving roller 23b is connected to a driving unit having a driving source such as a motor, and moves the intermediate transfer belt 23a in a circulating manner.

The tension roller 23c is a type of a driven roller that rotates to follow the rotation of the driving roller 23b, and includes a spring mechanism that applies a tension to the intermediate transfer belt 23a.

The driven roller 23d rotates with the rotation of the intermediate transfer belt 23a.

The primary transfer roller 23e is disposed to face the photosensitive drum 21a with the intermediate transfer belt 23a interposed therebetween, and releases a transfer current to the intermediate transfer belt 23a. Therefore, the toner image on each photosensitive drum 21a is firstly transferred to the intermediate transfer belt 23a.

The secondary transfer roller 23f secondly transfers the toner image on the intermediate transfer belt 23a to the recording sheet.

The cleaning portion 23g is provided at the downstream side of the driving roller 23b in the rotation direction of the intermediate transfer belt 23a and is provided at the upstream side of the first image forming unit 21. The cleaning portion 23g includes a cleaning blade that contacts the surface of the intermediate transfer belt 23a, and removes toner (waste toner) remaining on the intermediate transfer belt 23a. The waste toner removed by the cleaning portion 23g is transferred to the waste toner container 24 via a conveyance mechanism (not shown) including a spiral screw and the like.

Furthermore, in the example shown in the drawing, nothing is shown at the opposite side of the cleaning portion 23g with the intermediate transfer belt 23a interposed therebetween, however this is only for simplification of the drawing. In the actual apparatus, in order to efficiently remove the waste toner, there are provided a simple roller or plural rollers which are able to press the intermediate transfer belt 23a against the cleaning portion 23g during cleaning.

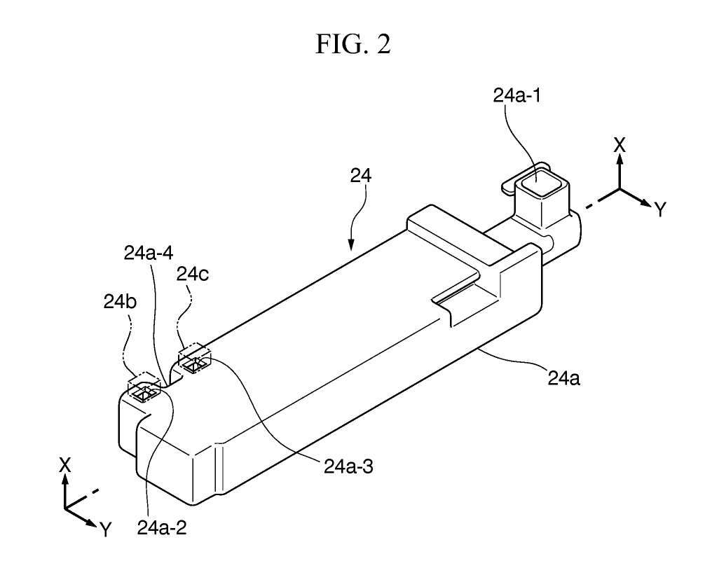

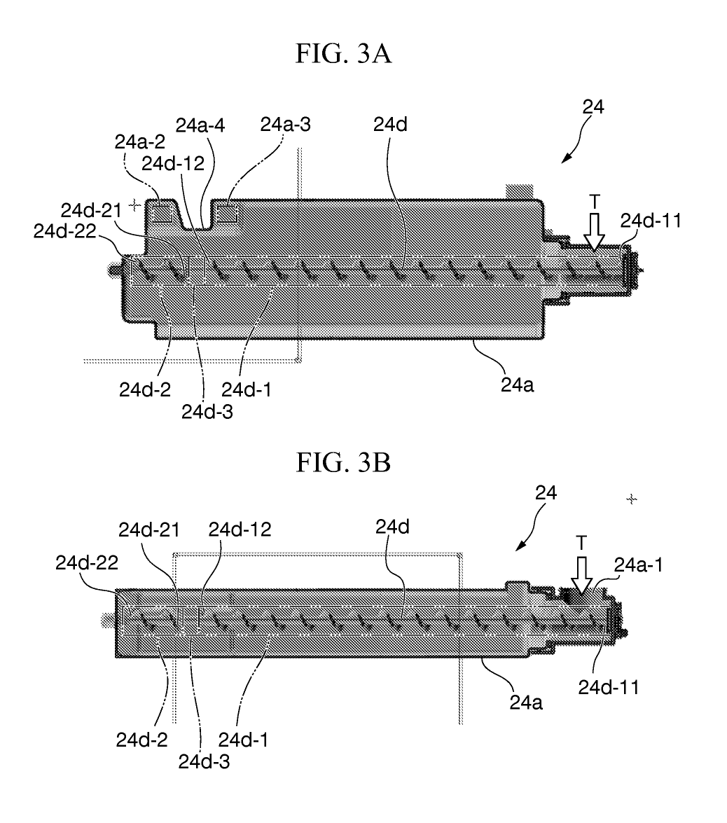

Hereinafter, the waste toner container 24 will be described by referring to FIGS. 2, 3A, and 3B as well as FIG. 1. The waste toner container 24 is a container that stores the waste toner T conveyed by the conveyance mechanism, and is detachably attached to the conveyance mechanism. A place provided with the waste toner container 24 is a place that ensures a comparatively large space inside the multifunctional machine A, and is a place that is designed so that the waster toner container is easily attached or detached when a cover (not shown) of the multifunctional machine A is opened. As shown in FIGS. 1 to 3B, the waste toner container 24 includes a storage container 24a, a full detection sensor 24b, a near detection sensor 24c, and a conveyance portion 24d.

The storage container 24a is a substantially rectangular parallelepiped body that has a predetermined space therein and is made of a synthetic resin, and stores the waste toner T while being provided in the horizontal direction. The storage container 24a includes a storage port 24a-1 which receives the waste toner T thereinto, a full detection window 24a-2, a near detection window 24a-3, and a partition portion 24a-4. The storage port 24a-1 is provided at the upper surface close to one end in the length direction of the storage container 24a, and is connected to the conveyance mechanism. The storage container 24a receives the waste toner T conveyed by the conveyance mechanism from the storage port 24a-1. The full detection window 24a-2 is provided at a full position to which the full detection sensor 24b is attached and which is close to the end at the opposite side of the storage port 24a-1 in the upper surface of the storage container 24a. The full detection window 24a-2 is an opening which receives light emitted from the full detection sensor 24b into the storage container 24a. The near detection window 24a-3 is provided at a near position to which the near detection sensor 24c is attached and which is closer to the storage port 24a-1 than the full detection window 24a-2 in the upper surface of the storage container 24a. The near detection window 24a-3 is an opening which receives light emitted from the near detection sensor 24c into the storage container 24a. The partition portion 24a-4 prevents the waste toner T that reaches the near position from directly moving to the full position before the storage container 24a is fully filled with the waste toner. The partition portion 24a-4 is provided to disturb the movement of the waste toner T between the near position and the full position at the inside of the storage container 24a.

The full detection sensor 24b is provided at the full position close to the end at the opposite side of the storage port 24a-1 along the length direction of the storage container 24a. The full detection sensor 24b detects whether the waste toner T reaches the full position which is the end of the storage container 24a, that is, the storage container 24a is fully filled with the waste toner. The full detection sensor 24b includes a light emitting element and a light receiving element which are disposed to face each other. The light emitting element emits light downward via the full detection window 24a-2. The light receiving element outputs a detection signal with the light emitted from the light emitting element to a CPU (not shown).

The near detection sensor 24c is provided at the near position which is closer to the storage port 24a-1 of the storage container 24a than the full detection sensor 24b, and includes a light emitting element and a light receiving element which are disposed to face each other. The near detection sensor 24c detects whether the waste toner T reaches the near position which is closer to the storage port 24a-1 than the full position, that is, the storage container 24a is nearly fully filled with the waste toner. As in the case of the full detection sensor 24b, the light emitting element emits light downward via the near detection window 24a-3, and the light receiving element outputs a detection signal with the light from the light emitting element to a CPU.

As shown in FIGS. 3A and 3B, the conveyance portion 24d is a screw conveyor that extends from the storage port 24a-1 (refer to FIG. 2) to the opposite end thereof along the length direction of the storage container 24a. The conveyance portion 24d includes an axial rod which extends along the length direction of the storage container 24a from the storage port 24a-1 and a spiral protrusion which is formed on the circumferential surface thereof. The waste toner T is conveyed from the storage port 24a-1 along the length direction thereof in a manner such that the conveyance portion 24d rotates about the axial rod. The conveyance portion 24d includes a first spiral protrusion 24d-1, a second spiral protrusion 24d-2, and a third range 24d-3.

The first spiral protrusion 24d-1 has a range where the spiral protrusion is formed from the vicinity of the storage port 24a-1 to that of the near position attached with the near detection sensor 24c (refer to FIG. 2). The first spiral protrusion 24d-1 conveys the waste toner T from the storage port 24a-1 to the near position.

The third range 24d-3 is provided between the first spiral protrusion 24d-1 and the second spiral protrusion 24d-2, and separates the first spiral protrusion 24d-1 and the second spiral protrusion 24d-2 from each other. Hereinafter, the end of the third range 24d-3 close to the first spiral protrusion 24d-1 is referred to as a starting point of the third range, and the end of the third range 24d-3 close to the second spiral protrusion 24d-2 is referred to as a end point of the third range.

The second spiral protrusion 24d-2 has a range where the spiral protrusion is provided from the end point of the third range to the vicinity of the full position where the full detection sensor 24b is attached (refer to FIG. 2). The second spiral protrusion 24d-2 conveys the waste toner T which reaches the near position and then passes by the third range 24d-3 to the full position.

The third range 24d-3 is a range where the spiral protrusion is not provided between the first spiral protrusion 24d-1 and the second spiral protrusion 24d-2. The third range 24d-3 is used to make the waste toner T pass therethrough at a speed lower than the conveyance speed of the first spiral protrusion and the second spiral protrusion.

Hereinafter, the end of the first spiral protrusion 24d-1 close to the storage port 24a-1 is referred to as an end 24d-11, and the end at the opposite side of the storage port 24a-1 is referred to as an end 24d-12.

Further, the end of the second spiral protrusion 24d-2 close to the storage port 24a-1 is referred to as an end 24d-21, and the end at the opposite side of the storage port 24a-1 is referred to as an end 24d-22.

The fixing unit 25 fixes the toner image transferred from the intermediate transfer unit 23 to the recording sheet onto the recording sheet by applying heat and pressure thereto. The fixing unit 25 is disposed at the conveyance path of the recording sheet. Further, the sheet feeding rollers 26 are respectively provided at the corresponding positions of the sheet feeding cassette 27 and the sheet feeding tray 28 on the lower side of the apparatus. By the sheet feeding rollers 26, the recording sheet is conveyed from the sheet feeding cassette 27 or the sheet feeding tray 28 to the intermediate transfer unit 23 as described above (specifically, between the driving roller 23b and the secondary transfer roller 23f).

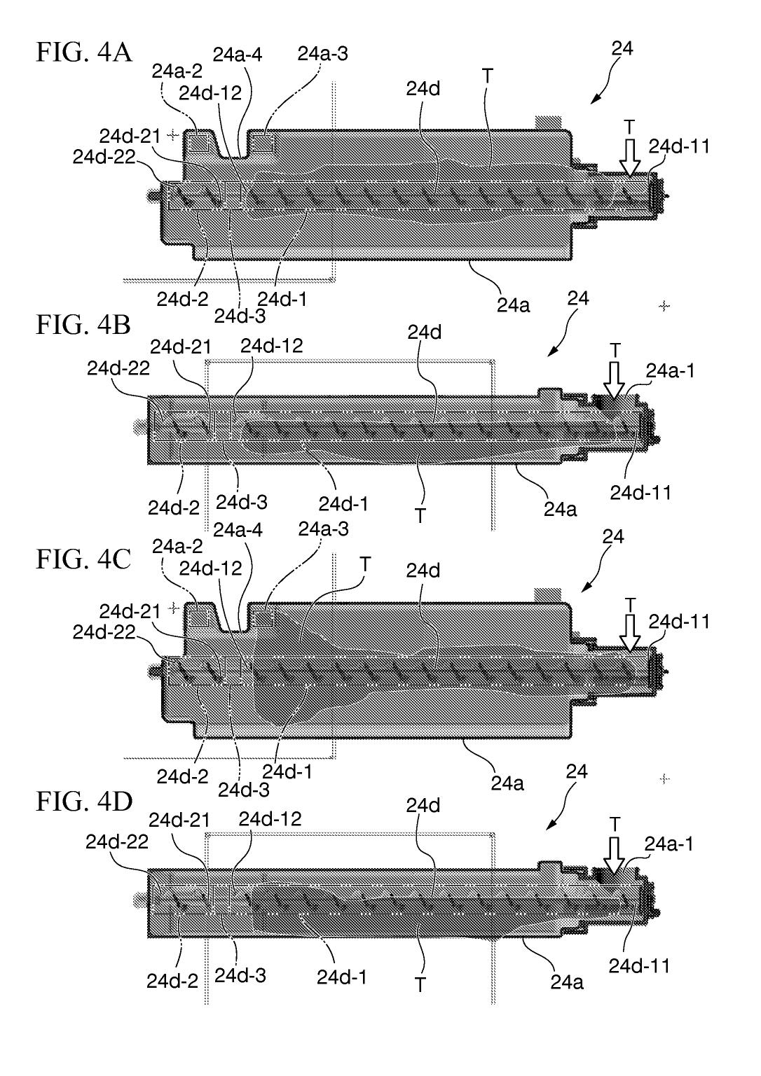

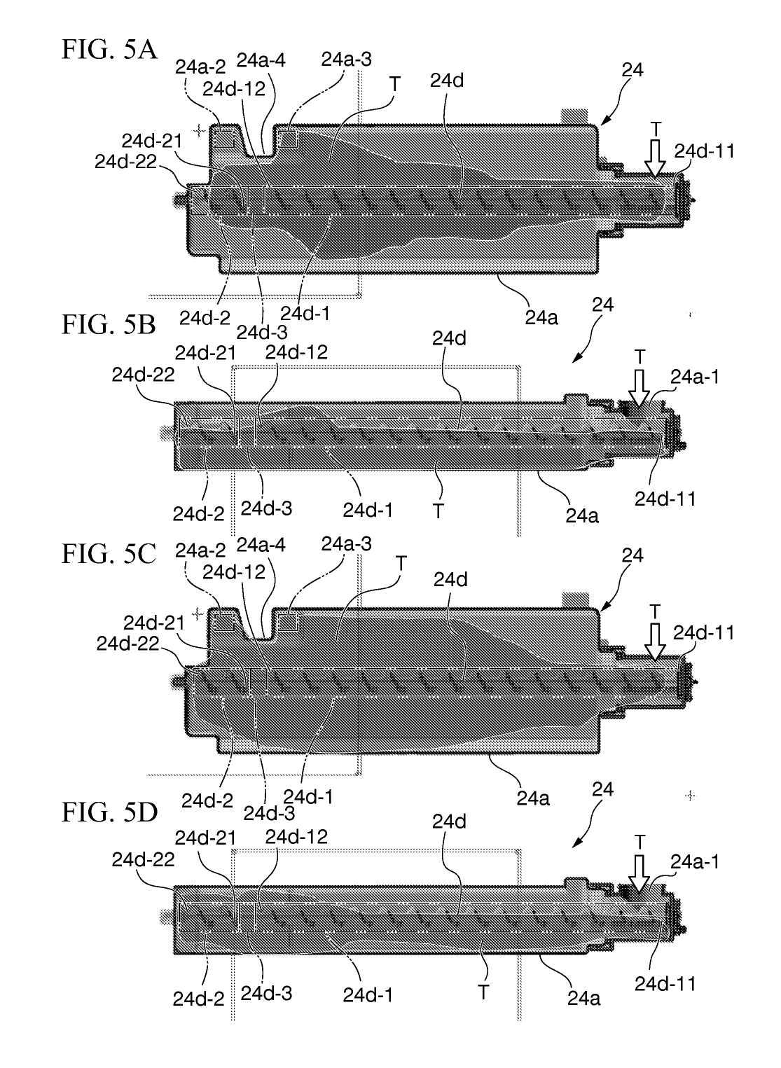

Next, the operation of the multifunctional machine A according to the embodiment with the above-described configuration will be described by referring to FIGS. 4 and 5.

First, a user who wants to copy a document using the multifunctional machine A sets the document on the image reading device 1. Then, the user starts copying using the multifunctional machine A.

When the copying is started, the multifunctional machine A performs image forming using the image forming unit 21. The multifunctional machine A conveys the waste toner T generated during the image forming using the conveyance mechanism, and stores the waste toner T in the waste toner container 24 in which the conveyance portion 24d rotates.

After the waste toner T drops from the storage port 24a-1 into the waste toner container 24, the waste toner T is conveyed from the storage port 24a-1 toward the end 24d-12 of the first spiral protrusion 24d-1 by the conveyance portion 24d disposed right below the storage port 24a-1. Since the diameter of the circular cross-section, which is perpendicular to the length direction of the conveyance portion 24d, is sufficiently smaller than the storage container 24a, the waste toner T present around the conveyance portion 24d is mainly conveyed. When this operation is continuously performed, the waste toner T reaches the end 24d-12 of the first spiral protrusion 24d-1 as shown in FIGS. 4A and 4B. At this time, the waste toner T is accumulated only around the conveyance portion 24d, and is not yet accumulated to be spread in the horizontal direction of the storage container 24a.

The waste toner T is not actively conveyed to the third range 24d-3 after it reaches the end 24d-12 of the first spiral protrusion 24d-1 since the third range 24d-3 without the spiral protrusion is provided in front of the end 24d-12 along the running direction of the conveyance. When the waste toner T is continuously supplied from the storage port 24a-1, the waste toner T staying at the end 24d-12 is accumulated to be spread in the height direction and the width direction in a manner of repeating depositing and flowing since the waste toner is suppressed from being conveyed to the third range. By this operation, as shown in FIGS. 4C and 4D, the waste toner T reaches the side surfaces close to the end 24d-11 and the end 24d-12. The near detection sensor 24c is attached onto the near detection window 24a-3 at the near position close to the end 24d-12. Accordingly, when the waste toner T approaches the periphery of the near position, the near detection sensor 24c detects the waste toner T. That is, it is detected that the waste toner T reaches just before the full detection sensor 24b. Therefore, the multifunctional machine A detects that the waste toner container 24 is in a state where it is not fully filled with the waste toner, but is nearly fully filled with the waste toner.

Furthermore, when the waste toner T is supplied from the storage port 24a-1, the waste toner T staying around the end 24d-12 of the first spiral protrusion 24d-1 is pressed by the waste toner T conveyed from behind, so that the waste toner T starts to be conveyed from the starting point of the third range to the end point of the third range. At this time, since the partition portion 24a-4 is provided between the near position and the full position, the waste toner T cannot directly move from the near position to the full position. When the waste toner T passes by the third range 24d-3 and reaches the end 24d-21 of the second spiral protrusion 24d-2 close to the storage port 24a-1, the conveyance of the waste toner T is promoted again by the second spiral protrusion 24d-2. Then, as shown in FIGS. 5A and 5B, the conveyance is stopped when the waste toner T reaches the end 24d-22 of the second spiral protrusion 24d-1. The waste toner T which cannot move anywhere is accumulated to be spread in the height direction and the width direction in a manner of repeating depositing and flowing. The full detection sensor 24b is attached onto the full detection window 24a-2 at the full position close to the end 24d-22. Accordingly, as shown in FIGS. 5C and 5D, when the waste toner T approaches the periphery of the full position, the full detection sensor 24b detects the waste toner T. That is, it is detected that the waste toner T reaches the full position of the storage container 24a. Therefore, the multifunctional machine A detects that the waste toner container 24 is in a state where it is fully filled with the waste toner.

As described above, in the multifunctional machine A according to the embodiment, since the third range 24d-3 without the spiral protrusion is provided between the first spiral protrusion 24d-1 and the second spiral protrusion 24d-2, it takes a certain amount of time for the waste toner T to move to the position of the full detection sensor 24b after it reaches the position of the near detection sensor 24c. As a result, it is possible to prevent erroneous detection in which full detection occurs immediately after near detection or full detection occurs before near detection.

While the embodiment of the invention has been described, the invention is not limited to the above-described embodiment, but may be modified, for example, as below.

In the above-described embodiment, the axial rod is configured so that the third range 24d-3 is not provided with the spiral protrusion, but the invention is not limited thereto.

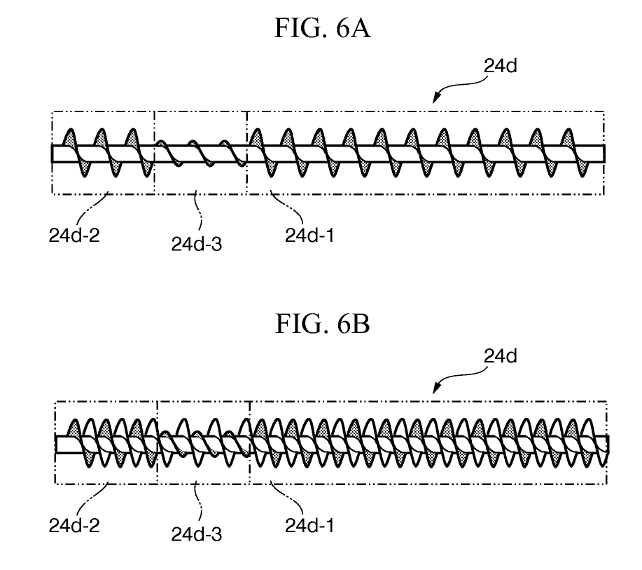

For example, as shown in FIG. 6A, in the third range 24d-3, the height of the spiral protrusion in the direction perpendicular to the circumferential surface of the axial rod may be set to be smaller than those of the first spiral protrusion 24d-1 and the second spiral protrusion 24d-2. Therefore, the speed of conveying the waste toner T in the third range may be set to be lower than those of the first spiral protrusion 24d-1 and the second spiral protrusion 24d-2.

Further, as shown in FIG. 6B, the first spiral protrusion 24d-1, the second spiral protrusion 24d-2, and the third range 24d-3 may be provided with a plurality of spiral protrusions disposed in parallel. In this case, in the third range 24d-3, the height of the spiral protrusion in the direction perpendicular to the circumferential surface of the axial rod in at least one of the plurality of spiral protrusions may be set to be smaller than those of the spiral protrusions of the first spiral protrusion 24d-1 and the second spiral protrusion 24d-2.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An image forming apparatus comprising:
a storage container which horizontally stores a waste toner received from a storage port;
a full detection sensor which detects whether the waste toner reaches a full position that is the end at the opposite side of the storage port inside the storage container;
a near detection sensor which detects whether the waste toner reaches a near position closer to the storage port than the full position; and
a conveyance portion which is provided inside the storage container, includes an axial rod, and rotates about the axial rod,
wherein the conveyance portion includes:
a first spiral protrusion which conveys the waste toner to the near position;
a second spiral protrusion which conveys the waste toner from the near position to the full position; and
a third range which is provided between the first spiral protrusion and the second spiral protrusion and through which the waste toner passes at a speed lower than the conveyance speed of the first spiral protrusion and the second spiral protrusion.

2. The image forming apparatus according to claim 1,
wherein the third range is not provided with a spiral protrusion.

3. The image forming apparatus according to claim 1,
wherein the third range is provided with a third spiral protrusion of which the height in the direction perpendicular to the circumferential surface of the axial rod is smaller than that of the first spiral protrusion.

4. The image forming apparatus according to claim 1,
wherein a third spiral protrusion is formed in the third range, and each of the first spiral protrusion, the second spiral protrusion, and the third spiral protrusion is formed as a plurality of spiral protrusions formed in parallel to each other, and
wherein in the third range, the height of at least one of the plurality of parallel spiral protrusions in the direction perpendicular to the circumferential surface of the axial rod is smaller than those of the first spiral protrusion and of the second spiral protrusion.

5. The image forming apparatus according to claim 1, further comprising:
a partition portion which is provided between the near position and the full position of the storage container and which disturbs the movement of the waste toner.

6. The image forming apparatus according to claim 2, further comprising:
a partition portion which is provided between the near position and the full position of the storage container and which disturbs the movement of the waste toner.

7. The image forming apparatus according to claim 3, further comprising:
a partition portion which is provided between the near position and the full position of the storage container and which disturbs the movement of the waste toner.

8. The image forming apparatus according to claim 4, further comprising:
a partition portion which is provided between the near position and the full position of the storage container and which disturbs the movement of the waste toner.
